(19) United States
(12) Patent Application Publication
(10) Pub. No.: US 2023/0253591 A1
(43) Pub. Date: Aug. 10, 2023

(54) FREEZE CAPABLE WATER SCRUBBER FOR FUEL CELL ENGINES

(71) Applicant: US Hybrid Corporation, Torrance, CA (US)

(72) Inventor: Daniel Orlowski, Manchester, CT (US)

(21) Appl. No.: 17/666,106

(22) Filed: Feb. 7, 2022

(51) Int. Cl. H01M 8/0668; H01M 8/04007; H01M 8/04223

(52) U.S. Cl. CPC H01M 8/0668; H01M 8/04059; H01M 8/04253

(57) ABSTRACT

A fuel cell engine generates electricity for electric vehicles or for industrial uses. The evaporatively cooled fuel cell engine incorporates de-ionized water-cooling process, in which de-ionized water flowing through the cooling subsystem becomes ionized with carbon dioxide. The water scrubber subsystem of the invention uses differences in partial pressures across a thin ion-exchange membrane to draw the contaminating ions out of the flow or stream of the circulating water. Because the partial pressures of carbon dioxide is different on either side of the membrane, the carbon dioxide ions move from the side of the circulating water to the anode exhaust purge side through the ion-exchange membrane in order to achieve equilibrium. This results in reducing the carbon dioxide ions (and any other gaseous ions) in the flow or stream of circulating water before the water enters the fuel cell stack. This results in greater fuel cell performance and a longer lasting de-ionizing filter.

### BACKGROUND

Fuel cell engines utilizing porous plate technology use de-ionized water to cool the fuel cell stack and provide a seal between reactants. In an evaporative system, the de-ionized water is reclaimed using a condenser back to an accumulator which stores the water. The water is then pumped back to the cell stack from the accumulator. However, this process of reclaiming water in the cathode exhaust stream, by its very nature, results in the reclaimed water becoming fully saturated with carbon dioxide ions. As a result, the reclaimed water is no longer de-ionized.

This modality addresses the issue of a de-ionized water-scrubbing process in an evaporatively cooled fuel cell system, in which the de-ionized water becomes ionized with carbon dioxide. The method and device of a water scrubber system according to the invention presented here uses differences in partial pressures across a thin ion-exchange membrane to draw the contaminating ions out of the flow or stream of the reclaimed water. On one side of the ion-exchange membrane is the flow or stream of reclaimed water saturated with carbon dioxide ions. On the other side is the anode exhaust purge stream, with nitrogen and hydrogen. Because the partial pressures of carbon dioxide is different on either side of the membrane, the CO₂ ions move from the side of the reclaimed water to the anode exhaust purge side through the ion-exchange membrane in order to achieve equilibrium.

The water scrubber process described above results in reducing the carbon dioxide ions (and any other gaseous ions) in the flow or stream of reclaimed water before the water enters or re-enters the cell stack. This results in greater fuel cell performance (higher voltage due to less resistive shorting through the water) and a longer lasting de-ionizing filter.

### BRIEF DESCRIPTION OF THE DRAWINGS

The detailed description is set forth with reference to the accompanying figures. The use of the same reference numbers in different figures indicates similar or identical items or features.

FIG. 1 is a general diagram of an example fuel cell engine.

FIG. 2 is a block diagram of the example fuel cell engine of FIG. 1, in greater detail.

FIG. 3 is a diagram of the subsystems of the example fuel cell engine according to FIGS. 1-2.

FIG. 4 is a diagram of an example water scrubber equipped sub-system for the fuel cell engine.

FIG. 5 is a flow diagram of a method for water scrubbing in a fuel cell engine.

FIG. 6 is a flow diagram of a method of manufacturing a fuel cell engine.

### DETAILED DESCRIPTION

This disclosure is directed to describing fuel cell engines and fuel cell electric vehicles. The example fuel cell engines described herein generate electricity for an electric vehicle or for industrial uses. The application of the subject invention to be disclosed hereinafter is not intended to be limited only to specific implementations or configurations of fuel cell engines. Rather, the subject invention is applicable to all embodiments of fuel cell engines or fuel cell electric vehicles that operate on the basic principles of electricity generation from fuel cells or electrochemical cells as known in the art.

Example Systems

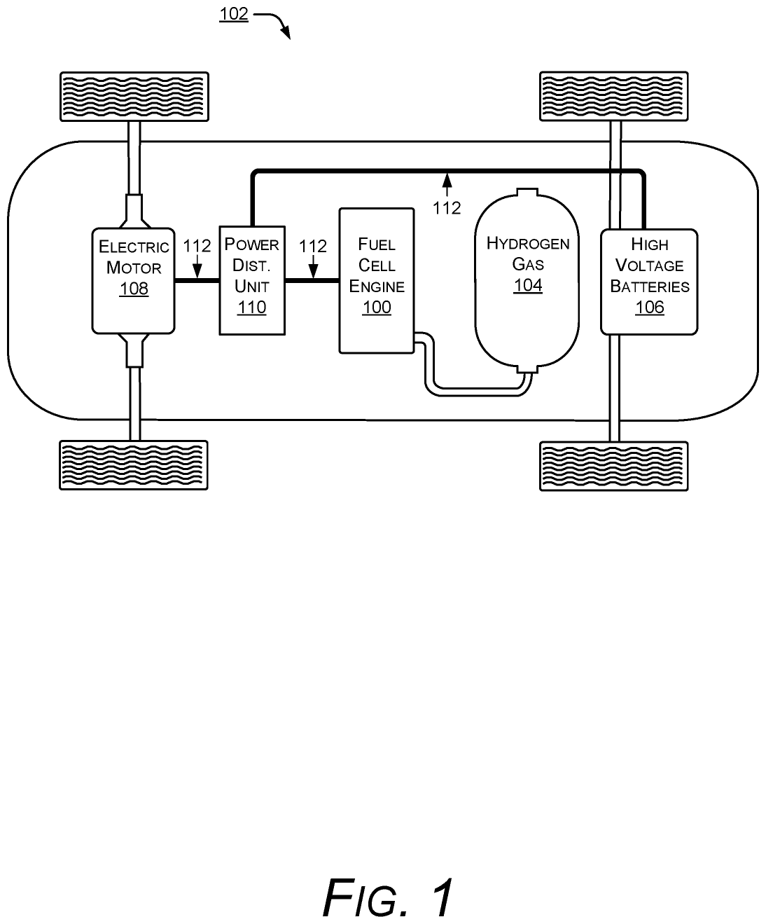

FIG. 1 shows a fuel cell engine 100 for a fuel cell electric vehicle (FCEV) 102. As shown, the example fuel cell engine 100 has a high-pressure supply of hydrogen gas 104 used as fuel for the fuel cell engine 100. One or more high voltage batteries 106 store energy from the fuel cell engine 100, and sometimes reclaim energy generated from braking as electrical energy for battery storage. The one or more high voltage batteries 106 may provide supplemental power to the electric (traction) motor 108 via the power distribution unit 110 of the vehicle 102. The main source of electric power for the electric motor 108 powering propulsion of the vehicle 102 is the fuel cell engine 100. The power distribution unit 110 of the vehicle 102 directs various high voltage electric currents of the fuel cell engine 100, high voltage batteries 106, and electric motor 108 along a high voltage power bus 112.

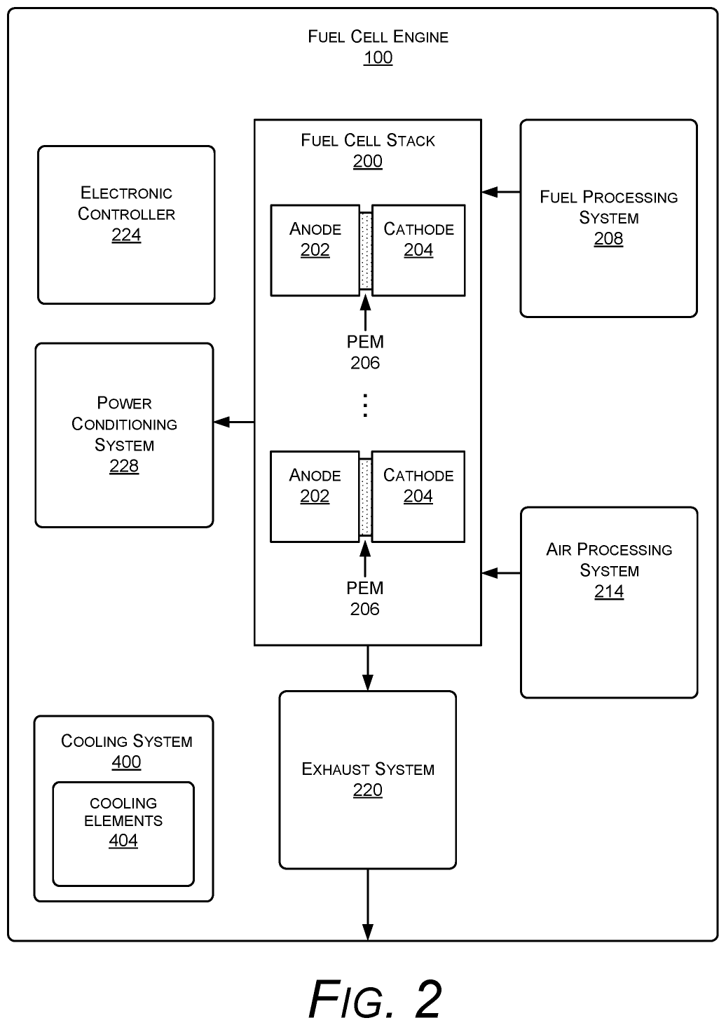

FIG. 2 is a block diagram of the example fuel cell engine of FIG. 1, in greater detail, wherein each cell of a fuel cell stack 200 has an anode 202 and a cathode 204 on either side of an intervening polymer electrolyte membrane (PEM) 206. A fuel processing system 208 for providing the hydrogen gas 104 to the fuel cell stack 200 has a fuel valve 210 to control the anode fuel pressure. An air processing system 214 provides ambient air to the fuel cell stack 200, and may be implemented using any of a blower, a turbocharger, a compressor, or other equivalent technology for injecting air (including oxygen) into the fuel cell stack 200. An electronic controller 224 of the fuel cell engine 100 manages and supervises all the operations of the fuel cell engine 100 during routine operation. An exhaust system 220 determines the disposition of a water vapor end product of the fuel cell stack 200 during operation, and in some implementations may have plumbing to recirculate unreacted hydrogen gas 104 back to the anodes 202 of the fuel cell stack 200 in conjunction with the fuel processing system 208. The present invention is one implementation of such an embodiment, as will be explained in detail hereinbelow.

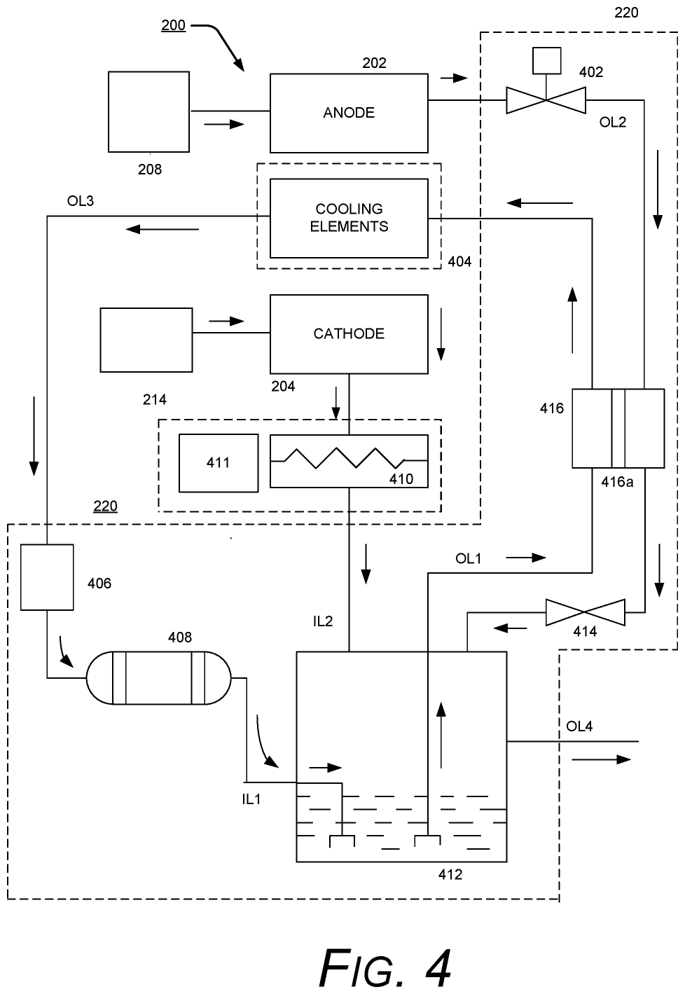

The example fuel cell engine 100 may also have a water scrubbing subsystem 400, that include cooling elements 404 (See FIG. 4 described hereinafter) that are formed, for example, to be integrated with the heat-producing anodes 202 and cathodes 204 of the fuel cell engine 100. In routine operation, the fuel cell engine 100 produces heat, which evaporates water from the cathodes 204 from the heat producing reaction of hydrogen and oxygen. The evaporated water, now fully saturating the exhaust from the cathodes 204, is cooled in the heat exchanger 410 to remove heat from the system.

During routine operation of the fuel cell engine 100 producing electric power, the fuel processing system 208 supplies the hydrogen gas 104 to the anodes 202 of the fuel cell stack 200 at well-calculated pressures. The fuel processing system 208 may also filter the hydrogen gas 104 prior to entry of the hydrogen gas 104 into valves of the fuel processing system 208. In one implementation, the fuel processing system 208 may control the pressure of the hydrogen gas 104 at the anodes 202 in real time along a continuum of possible pressure values, based on the current states and power requirements of the vehicle 102 or other non-vehicular load being powered by the fuel cell engine 100.

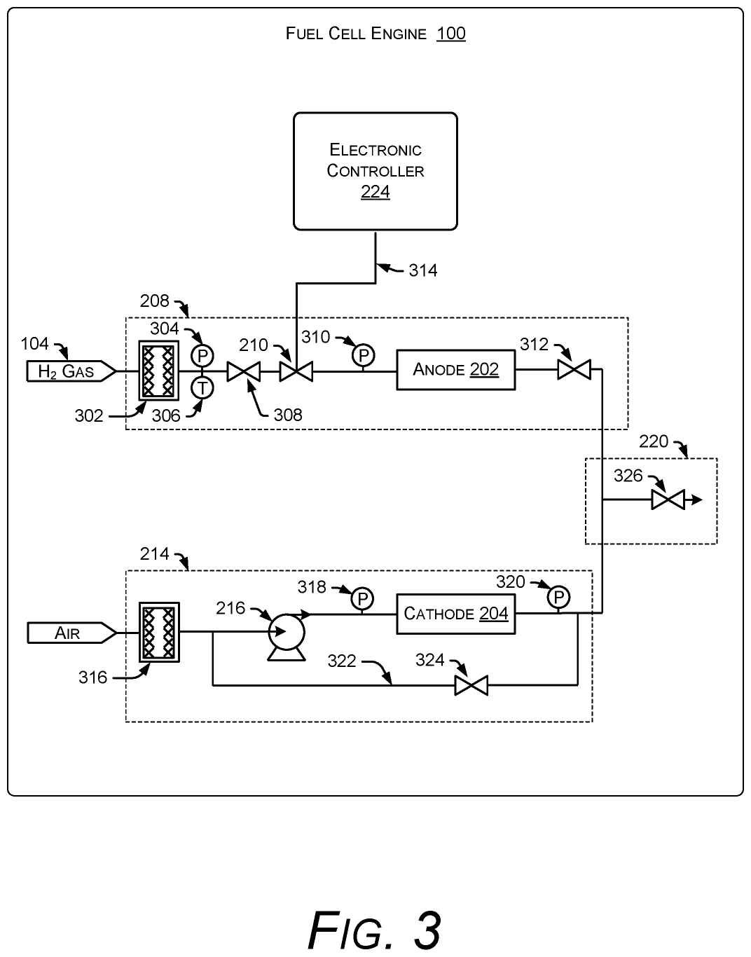

FIG. 3 shows a schematic diagram of the example fuel cell engine 100 presented in FIGS. 1-2, including various flow lines and valves for gases. The approximate domains of the fuel processing system 208, air processing system 214, and exhaust system 220 are shown in dashed boxes.

The example fuel processing system 208 includes a hydrogen gas filter 302 in a flow line to the anode 202. For hydrogen gas 104 entering the fuel processing system 208, the flow line has a pressure sensor/transmitter 304, and a temperature sensor/transmitter 306 providing input to the electronic controller 224. A flow valve 308 allows hydrogen gas 104 into the flow line or closes off the supply of hydrogen gas 104.

In an implementation of the fuel processing system 208, a second pressure sensor/transmitter 310 are positioned downstream from the electronically controlled fuel valve 210, thereby providing the pressure of the hydrogen gas 104 at the surface of the anodes 202. The fuel processing system 208 also has a purge valve 312 on the exhaust side of the anodes 202, adjustable to provide backpressure and/or exhaust flow of unused hydrogen gas 104. In some implementations, the fuel processing system 208 has a recirculation loop (not included in FIG. 3) to return unreacted hydrogen gas 104 back to the inputs of the anodes 202 to be used as fuel.

The example air processing system 214 has an air filter 316 in a flow line to the cathodes 204. Ambient air entering the air processing system 214 via the air filter 316 is inducted using, for example, a blower 216 (or turbocharger or compressor). An air pressure sensor/transmitter 318 resides in the flow line between the blower 216 and the cathode 204. A second air pressure sensor/transmitter 320 of the air processing system 214 may be situated in the exhaust flow line coming from the cathodes 204. The air processing system 214 may have a bypass loop 322 with a cathode bypass valve 324 to partially offload volumes of air incoming to the blower 216 and the cathode 204.

The exhaust system 220 may handle the gaseous outputs from the anodes 202 and from the cathodes 204 in various ways. The combined outputs contain air and some hydrogen gas 104; and water vapor as a reaction product of the energy/electricity/heat power production. The exhaust system 220 has an exhaust valve also known as the cathode exhaust valve 326.

The electronic controller 224 manages the operation of the fuel cell engine 100, and supervises the various states of the components, the production of electricity between anodes 202 and cathodes 204 of the fuel cell stack 200 (not shown as such in FIG. 3), and the pressures of the gases in the system: hydrogen gas 104 as fuel, air containing oxygen as oxidant, and water vapor.

In routine operation, a fuel cell stack 200 is the source of electrical energy during fuel cell operation: hydrogen gas 104 (the fuel) releases electrons on the anode side of the fuel cell creating an electron flow for an electrical circuit:

2H₂→4H⁺+4e⁻

while the hydrogen ions (also known as hydrogen cations, hydrons, protons, or H⁺) travel through the PEM 206 (electrolyte) to the cathode 204 to combine with oxide anions being formed by reduction of oxygen gas at the cathode 204. The reduction of the oxygen is accomplished by the electrons that were generated at the anode 202 and have flowed through an electrical circuit (wires) of the vehicle 102 or other electrical load:

O₂+4e⁻→2O⁻²

From the two electrochemical half-reactions above, the overall chemical reaction of the fuel cell engine 100 in generating electric power is a combination of the hydrogen gas 104 with oxygen gas through the agency of the fuel cell stack 200, resulting in electricity, water vapor, and heat:

2H₂+O₂→2H₂O vapor+electron flow+heat

Water Scrubbing Subsystem

FIG. 4 is a diagram of an example water scrubbing subsystem 400 equipped with a water scrubber for the fuel cell engine 100 that integrates with the fuel processing system 208, the air processing system 214 and the exhaust system 220. Specifically, elements of the fuel processing system 208, the air processing system 214 and the exhaust system 220 are incorporated into the structure and operation of the water scrubbing subsystem 400, as will be discussed hereinbelow. As noted above, during routine operation of the fuel cell engine 100, heat is produced in the fuel cell stacks 102, which is removed through evaporation of product water and circulating water and then cooled in the exhaust system to reclaim the proper amount of circulating water.

In one embodiment of the fuel cell stack 200, the cooling elements 404 may be machined so as to be integrated into either the anode 202 or cathode 204 (not shown). The other of the anode 202 or cathode 204 is then formed as a flat plate, whereby the anode 202, the cathode 204, the polymer electrolyte membrane (PEM) 206 and the cooling elements 404 are sandwiched together into the fuel cell stack 200.

During the production of electricity by the fuel cell stack 200, the cooling elements 404 implement the process known as evaporative cooling. Specifically, de-ionized water continuously flows into and through the cooling elements 404, wherein the cooling elements are effectively maintained wet and saturated with the de-ionized water.

The heat produced as a result of the reaction of the hydrogen H₂ from the anode 202 with the oxygen O₂ in the ambient air from the air processing system 214 is absorbed by the de-ionized water flowing through the cooling elements 404. Specifically, as heat is generated during the reaction between the hydrogen gas H₂ 104 and the oxygen O₂ in the ambient air provided by the air processing system 214, the heat is transferred to the de-ionized water causing the de-ionized water to evaporate carrying off the heat and cooling the fuel cell stack 200 in the same manner as sweating cools a human body. The evaporated water is exhausted out of the cathode 204 along with the non-reacted components of the ambient air, including but not limited to oxygen O₂, carbon dioxide CO₂, and nitrogen N₂. In routine operation, the typical oxygen content of the incoming ambient air may be approximately 20.9%. When exhausted from the cathode 204, the oxygen content of the air may be reduced to as low as 9.6%.

Evaporated water resulting from the cooling of the fuel cell stack 200, along with water H₂O particles released from the reaction, carbon dioxide CO₂, and other non-reacted components from the ambient air, are exhausted from the cathode 204 and flow into a heat exchanger 410. The heat exchanger 410 may incorporate a radiator-type structure 411 or other similar heat transfer mechanism known in the art to transfer heat out of the exhausted fluid components entering the heat exchanger 410. This results in the evaporated water converting back to liquid water. The exhausted components from the heat exchanger 410 flow to an accumulator/separator 412.

Excess de-ionized water that was not absorbed into the cooling elements 404 or evaporated in the cooling elements 404 during operation flows out of the cooling elements 404 via output line OL3 through a pump 406 to a demineralizer filter 408 and then outputted to the accumulator/separator 412. That de-ionized water then combines with the reclaimed water H₂O and carbon dioxide CO₂ ions from the heat exchanger 410 in the accumulator/separator 412.

In the course of the operation described above, the carbon dioxide CO₂ and the reclaimed water in the heat exchanger 410 interact with each other, and then with the de-ionized water from the demineralizer filter 408. For example, within the heat exchanger 410 or the radiator structure 411, in an embodiment wherein the heat exchanger 410 and/or the radiator structure 411 surface areas on which the evaporated water condense, carbon dioxide CO₂ from the ambient air and exhausted from the cathode will naturally permeate into the water condensation on those surface areas. Since the concentration of oxygen is lower, the partial pressure of the carbon dioxide CO₂ is higher. This exacerbates the issue of carbon dioxide CO₂ contamination by increasing the rate and concentration of carbon dioxide CO₂ in the condensed water. The condensate water that is thus contaminated by the carbon dioxide CO₂ ions will then mix with the de-ionized water in the accumulator/separator 412, bypassing the filtering done by the demineralizer filter 408. Repeated cycling of this interaction saturates the de-ionized water collected in the accumulator/separator 412 with at least the carbon dioxide CO₂ ions effectively ionizing the water and rendering it ineffective. This can result in degradation in the operational life of components such as the demineralizer filter, as well as decreased performance in the cooling system and in the overall operation of the fuel cell engine 100.

To remove the carbon dioxide CO₂ ions from the ion-saturated water in the accumulator/separator 412, the water flows through a first output line OL1 to a separator 416. The separator 416 incorporates a CO₂ removal membrane 416a formed to allow carbon dioxide CO₂ ions to permeate through the CO₂ removal membrane 416a or at least migrate toward the CO₂ removal membrane 416a, and thus be removed or transferred from the saturated water, thereby effectively de-ionizing the water again for use in the cooling elements 404.

At the same time, hydrogen H₂ gas exhausted from the anode 202 along with nitrogen N₂ gas present with the hydrogen H₂ gas flow through a second output line OL2 through a control valve 402 and then to the separator 416 on the opposite side of the CO₂ removal membrane 416a as part of the removal of carbon dioxide CO₂ ions from the ionized water flowing out from the accumulator/separator 412. The flow control valve 402 is used to control the bleeding off of un-reacted hydrogen H₂ gas, such as for controlling the fuel processing system 208, and to purge nitrogen N₂ gas that may be present. Similarly, flow control valve 414 located at the output of the separator 416 to the accumulator/separator 412 acts a back pressure valve to regulate the removal of hydrogen H₂ gas and nitrogen N₂ gas that is now contaminated with carbon dioxide CO₂ ions that was transferred from the separator 416.

The permeating or migrating of the carbon dioxide CO₂ ions thru the CO₂ removal membrane 416a is effected via partial pressure differences between the various components present in the output lines OL1 flowing through the separator 416, as well as partial pressure differences between the feed side and the permeate side of the CO₂ removal membrane 416a. Since there is no carbon dioxide CO₂ present in the OL2 line, there exists a driving force to balance the partial pressures of the carbon dioxide CO₂ to equilibrium on both sides of the membrane.

The permeance, permeability and efficiency of the CO₂ removal membrane 416a is determined by the selection and tuning of such characteristics as the membrane material, the surface area of the membrane, and the membrane thickness. By selecting/tuning these characteristics of the separator 416 and the CO₂ removal membrane 416a, performance of the water scrubbing subsystem 400 can be optimized in accordance with performance and operation requirements of the fuel cell engine 100.

An advantage of using the separator 416 to effect the removal of the carbon dioxide CO₂ ions instead of relying on the demineralizer structure 408 to remove any contaminants is that the separator 416 allows the designing of the water scrubbing subsystem 400 so that the de-ionized water flows back into the accumulator/separator 412 or other reservoir that may be incorporated for storage during non-operation of the fuel cell engine 100. As such, this can prevent the freezing of the de-ionized water in any flow lines or other components that can be damaged or compromised by the presence of frozen water. For example, demineralizer devices known in the art, such as that which could be used as the demineralizer filter 408, are designed to operate similar to conventional oil filters where water can accumulate in the body of the filter over time. Such accumulations of water, especially if frozen, can damage the demineralizer filter or at least prevent the device from operating correctly.

In an embodiment of the fuel cell engine 100, water scrubbing subsystem 400 may be designed or configured such that the positions of components such as the fuel cell stacks 200, the heat exchanger 410, the pump 406, separator 416 and the accumulator/separator 412, along with their connecting flow lines, relative to one another facilitates drainage flow of the de-ionized water by gravity. In a further embodiment, the shutdown operation of the fuel cell engine 100 may include controlling the water scrubbing subsystem 400 to drain the de-ionized water into the accumulator/separator 412 or other reservoir using a combination of a controllable pump (i.e., pump 406) and shut-off valves, as would be known in the art. This same combination of a controllable pump and shut-off valves may be used to re-circulate the de-ionized water into the water scrubbing subsystem 400 as part of the startup operation of the fuel cell engine 100.

The separator 416 may be constructed from a conventional device designed to separate carbon dioxide CO₂ from fluid streams as known in the art. The performance characteristics of such a carbon dioxide CO₂ separator would be based on the designing and/or selecting the materials, surface area, internal architecture of the separator 416 and the CO₂ removal membrane 416a to maximize or at least increase the rate and efficiency of CO₂ removal according to the operating requirements and characteristics of the fuel cell engine 100. For example, in an embodiment, the flow rate of de-ionized water through the water scrubbing subsystem 400 may be 6 liters/min.

The de-ionized water from the separator 416 is outputted via the output line OL1 back to the cooling elements 404, while the gaseous components that include the un-reacted hydrogen H₂ gas 104 exhausted from the anode and the separated carbon dioxide CO₂ ions flow back via the output line OL2 to the accumulator/separator 412. The accumulator/separator 412 may be configured to have the exhausted hydrogen H₂ gas 104, the separated carbon dioxide CO₂ ions and other gaseous components present flow out through an output line OL4 to an exhaust port (not shown). Alternatively, the accumulator/separator 412 may be configured to have the exhausted hydrogen H₂ gas 104 flow back into the fuel processing system 208 for re-use. Other gaseous components may be reclaimed or re-used out of the accumulator/separator 412 as would be known in the art.

In addition to the operational characteristics of the water scrubbing subsystem 400 as described above, it is understood that the water scrubbing subsystem 400 is also designed and configured to withstand prolonged operation in an automotive environment, including but not limited to an operating temperature range of around −40° C. to 125° C.

Example Processes

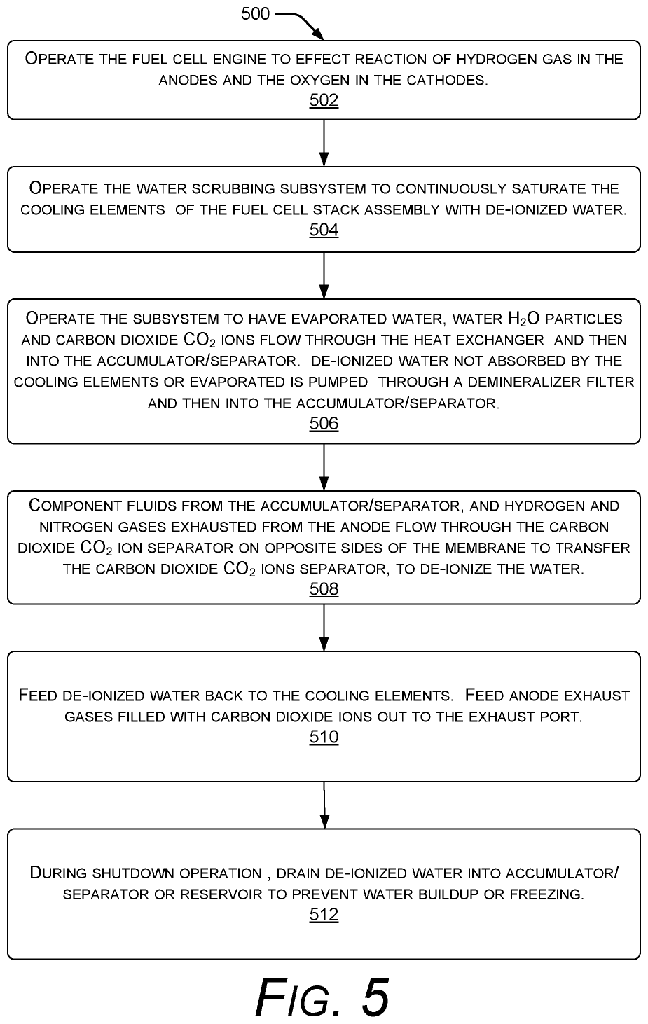

FIG. 5 shows an example method 500 for operating a fuel cell engine while performing water scrubbing and reclamation in a fuel cell engine. In the flow diagram of FIG. 5, operations of the example method 500 are shown in individual blocks. The order in which the operations are described in the example method 500 is not intended to be construed as a limitation, and any number of the described blocks can be combined in any order and/or in parallel to implement the process.

At block 502, the fuel cell engine is operated to effect the reaction of hydrogen gas in the anodes and the oxygen of the ambient air in the cathodes, all in the fuel cell stack assembly.

At block 504, the water scrubbing subsystem is operated to continuously saturate the cooling elements that are integrated into the anodes and cathodes of the fuel cell stack assembly with de-ionized water.

At block 506, the water scrubbing subsystem is further operated to have evaporated water carrying heat away from the fuel cell stack, water H₂O particles released from the reaction and carbon dioxide CO₂ ions flow through the heat exchanger to reclaim the evaporated water and then into the accumulator/separator. At the same time, the de-ionized water that was not absorbed by the cooling elements or evaporated is pumped out of the cooling elements through a demineralizer filter and then into the accumulator/separator.

At block 508, component fluids from the accumulator/separator flow through output lines to the carbon dioxide CO₂ ion separator, while at the same time, hydrogen and nitrogen gases exhausted from the anode flow through output lines also to the carbon dioxide CO₂ ion separator on the opposite side of the CO₂ removal membrane 416a, to remove the carbon dioxide CO₂ ions and de-ionize the water.

At block 510, de-ionized water flows out of the carbon dioxide CO₂ ion separator and is fed back into the cooling elements, while the anode exhaust gases flow out of the carbon dioxide CO₂ ion separator to the accumulator/separator.

At block 512, during shutdown operation of the fuel cell engine, the de-ionized water is controllably pumped or drained into the accumulator/separator or a reservoir to prevent water buildup or freezing in any of the components of the water scrubbing subsystem.

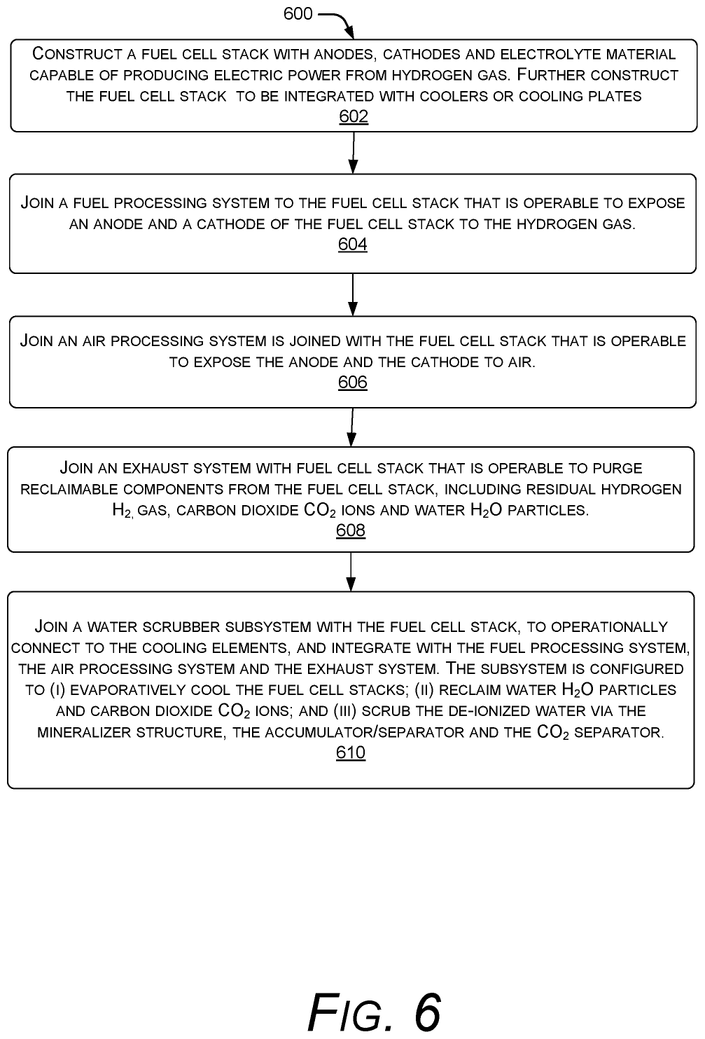

FIG. 6 shows an example process 600 for making a fuel cell engine that incorporates a water scrubbing subsystem. In the flow diagram of FIG. 6, operations of the example process 600 are shown in individual blocks. The order in which the operations are described in the example process 600 is not intended to be construed as a limitation, and any number of the described blocks can be combined in any order and/or in parallel to implement the process.

At block 602, a fuel cell stack is obtained for making a fuel cell engine, the fuel cell stack being constructed with anodes, cathodes, and electrolyte material capable of producing electric power from hydrogen gas. The fuel cell stack is constructed to be integrated with coolers or cooling elements.

At block 604, a fuel processing system is joined with the fuel cell stack, wherein the fuel processing system may comprise one or more first valves operable to controllably expose an anode and a cathode of the fuel cell stack to the hydrogen gas.

At block 606, an air processing system is joined with the fuel cell stack, wherein the air processing system comprises one or more second valves operable to controllably expose the anode and the cathode to air in coordination with the one or more first valves.

At block 608, an exhaust system is joined with the fuel cell stack, wherein the exhaust system comprises one or more third valves operable to purge reclaimable components from the fuel cell stack, including residual hydrogen H₂, gas, carbon dioxide CO₂ ions and water H₂O particles, in coordination with the one or more first valves and the one or more second valves.

At block 610, a water scrubber subsystem is joined with the fuel cell stack, wherein the water scrubbing subsystem is operationally connected to the coolers or cooling elements in the fuel cell stacks, and thus integrated with the cooling system, along with the fuel processing system, the air processing system, the exhaust system. The cooling system and thus the water scrubbing subsystem may then be filled with de-ionized water. In operation, the water scrubbing subsystem is capable of (i) evaporatively cooling the fuel cell stacks; (ii) reclaiming the evaporated water, along with water H₂O particles are released from the reaction and carbon dioxide CO₂ ions via the heat exchanger; and (iii) scrubbing the de-ionized water via the mineralizer structure, the accumulator/separator, and the carbon dioxide CO₂ ion separator.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. An apparatus, comprising:
a fuel cell engine for producing electric power from a hydrogen gas;
a cell stack of the fuel cell engine;
a fuel processing system of the fuel cell engine operable to expose an anode of the cell stack and/or a cathode of the cell stack to the hydrogen gas;
an air processing system of the fuel cell engine operable to expose the anode and/or the cathode to air;
an exhaust system of the fuel cell engine operable to remove reaction components and unreacted components from the anode and the cathode;
a cooling system of the fuel cell engine operable to evaporatively cool the anode and cathode of the cell stack with water; and
a water scrubbing subsystem operable to at least one of reclaim the reaction components and unreacted components exhausted from the anode and the cathode, and remove carbon dioxide ions from de-ionized water contaminated with carbon dioxide ions.

2. The apparatus of claim 1, wherein the cooling system includes
at least one cooling element operatively connected in and between the anode and cathode of the cell stack and configured to have the de-ionized water continuously flowing therethrough to evaporatively cool the anode and the cathode during operation, and
a heat exchanger operatively connected to receive evaporated de-ionized from exhausted from the cathode, and to remove heat from and re-liquify at least the evaporated de-ionized water.

3. The apparatus of claim 2, wherein the water scrubbing subsystem includes:
an accumulator/separator operatively connected to receive at least one of the re-liquified water reclaimed from the heat exchanger and de-ionized water exhausted from the at least one cooling element,
a carbon dioxide ion separator operatively connected to receive a first output flow from the accumulator/separator and a second output flow from the anode, the first output flow providing at least the re-liquified water that is contaminated with carbon dioxide ions to a first side of the carbon dioxide ion separator, the second output flow providing gaseous components exhausted from the anode to a second side of the carbon dioxide ion separator, the carbon dioxide ion separator including a carbon dioxide removal membrane between the first and second sides of the carbon dioxide ion separator,
wherein the carbon dioxide removal membrane is configured such that the carbon dioxide ions in the contaminated water on the first side move via the carbon dioxide removal membrane to the gaseous components in the second side in response to a difference in partial pressure between the carbon dioxide ions and other components present.

4. The apparatus of claim 3, wherein the water scrubbing subsystem further includes:
a demineralizer structure operatively connected to receive the de-ionized water from the at least one cooling element so as to demineralize the de-ionized water and then output the de-ionized water to the accumulator/separator.

5. A method of operating a fuel cell engine for producing electric power from a hydrogen gas, comprising the steps of:
providing a cell stack of the fuel cell engine, the cell stack having an anode, a cathode, and an electrolyte material therebetween;
inputting hydrogen gas into the anode so as to expose the anode and/or the cathode of the cell stack to the hydrogen gas;
inputting air into the cathode so as to expose the cathode and/or the anode to air, wherein the exposure of the hydrogen gas and the air via the anode, the cathode and the electrolyte membrane generates a reaction therebetween;
exhausting reaction components and unreacted components from the anode and the cathode;
continuously flowing de-ionized water through cooling elements integrated with the anode and cathode so as to evaporatively cool the anode and cathode of the cell stack during operation;
receiving evaporated de-ionized water exhausted from the cathode in a heat exchanger so as to re-liquify the evaporated water;
reclaiming the re-liquified water from the heat exchanger and gaseous components exhausted from the anode; and
removing carbon dioxide ions from de-ionized water contaminated with carbon dioxide ions.

6. The method of claim 5, wherein the step of reclaiming includes:
providing an accumulator/separator for receiving the re-liquified water from the heat exchanger and de-ionized water flowing from the at least one cooling element,
providing a carbon dioxide ion separator for receiving a first output flow from the accumulator/separator and a second output flow of gaseous components exhausted from the anode,
directing the first output flow providing the de-ionized water that is contaminated with carbon dioxide ions to a first side of the carbon dioxide ion separator,
directing the second output flow from the anode to a second side of the carbon dioxide ion separator,
separating the carbon dioxide ions via a carbon dioxide removal membrane between the first and second sides of the carbon dioxide ion separator,
wherein the carbon dioxide ions in the contaminated de-ionized water on the first side transfer via the carbon dioxide removal membrane to the gaseous components in the second side in response to a difference in partial pressure between the carbon dioxide ions and other components present.

7. The method of claim 5, wherein the step of reclaiming the reaction components and unreacted components further includes:
demineralizing the de-ionized water from the at least one cooling element and then outputting the de-ionized water to the accumulator/separator.

8. The method of claim 5, further comprising the steps of:
inputting the de-ionized water from which the carbon dioxide ions are removed back to the at least one cooling element;
inputting the gaseous components from the second side of the carbon dioxide ion separator to the accumulator/separator.

9. The method of claim 5, wherein the step of inputting the gaseous components from the second side of the carbon dioxide ion separator to the accumulator/separator includes flowing the gaseous components to an exhaust port.

10. The method of claim 5, further comprising the step of:
during shutdown operation of the fuel cell engine, at least one of controllably pumping and draining the de-ionized water into the accumulator/separator or a reservoir to prevent water buildup or freezing.

11. A process of making a fuel cell engine, comprising the steps of:
providing a fuel cell stack, the fuel cell stack including anodes, cathodes, and electrolyte material capable of producing electric power from hydrogen gas;
forming cooling elements so as to be integrated with the anodes and cathodes, the cooling elements being formed to continuously flow de-ionized water therethrough;
joining a fuel processing system with the fuel cell stack;
joining an air processing system to the fuel cell stack;
joining an exhaust system to the fuel cell stack; and
joining a water scrubbing subsystem to the fuel cell stack, wherein the water scrubbing subsystem is operationally connected to the cooling elements, and integrated with the fuel processing system, the air processing system, and the exhaust system, wherein a carbon dioxide ion separator is operatively connected to receive de-ionized water contaminated with carbon dioxide ions from the cooling elements during operation, the carbon dioxide ion separator being configured to remove the carbon dioxide ions therefrom.

12. The process of claim 11, wherein the water scrubbing subsystem is configured for evaporatively cooling the fuel cell stacks; reclaiming de-ionized water evaporated in the fuel cell stacks during operation; and removing carbon dioxide ions from the reclaimed water contaminated therewith.

13. The process of claim 11, wherein the step of joining the water scrubbing subsystem further includes:
configuring the cooling elements to continuously flow de-ionized water therethrough for saturating the fuel cell stacks so as to evaporatively cool the fuel cell stacks during operation,
providing a heat exchanger operatively connected to receive de-ionized water evaporated from cathode exhaust and configured to re-liquify the evaporated water,
providing an accumulator/separator operatively connected to receive the re-liquified water from the heat exchanger and de-ionized water exhausted from the cathode,
providing a carbon dioxide ion separator operatively connected to receive the re-liquified water and exhausted de-ionized water from the accumulator/separator through a first flow side thereof and receive gaseous components exhausted from the anode through a second flow side thereof during operation, the carbon dioxide ion separator being configured to transfer carbon dioxide ions from the first flow side to the second flow side via a carbon dioxide removal membrane therebetween.
